(19) United States
(12) Patent Application Publication
(10) Pub. No.: US 2014/0317521 A1
(43) Pub. Date: Oct. 23, 2014

(54) METHOD FOR HAVING MULTIPLE INPUT INTERFACES ON A COMPUTERIZED MOBILE DEVICE

(71) Applicant: SCREENOVATE TECHNOLOGIES LTD., Ra'anana (IL)

(72) Inventor: Matan SHAPIRA, Tel Aviv (IL)

(21) Appl. No.: 14/255,285

(22) Filed: Apr. 17, 2014

Related U.S. Application Data
(60) Provisional application No. 61/813,259, filed on Apr. 18, 2013.

(51) Int. Cl. H04L 29/08

(52) U.S. Cl. CPC H04L 67/025
USPC 715/740

(57) ABSTRACT

A method for enabling multiple input interfaces on a computerized mobile device is provided herein. The method comprises: (i) enabling default input interface of the computerized mobile device as a mobile device; (ii) using the input interface of the computerized mobile device as a mobile device to stream a content of first application on a remote screen which is different from the displayed content on the mobile device; (iii) enabling transition between the input interfaces of the computerized mobile device and the remote input interface of the displayed content on the remote screen, according to a gesture which is controlled by a user, wherein at least one gesture switch the input interface to control the content of the first application on the remote screen and at least a second gesture switch the input interface of the computerized mobile device to operate applications on a screen of the computerized device.

### TECHNICAL FIELD

The present invention relates to the field of computerized mobile device, and more particularly, to enabling multiple input interfaces on a computerized mobile device.

### SUMMARY OF INVENTION

According to some embodiments of the invention a method for enabling multiple input interfaces on a computerized mobile device is provided herein. The method comprises the following steps: (i) enabling default input interface of the computerized mobile device as a mobile device; (ii) using the input interface of the computerized mobile device as a mobile device to stream a content of first application on a remote screen which is different from the displayed content on the mobile device; and (iii) enabling transition between the input interfaces of the computerized mobile device and the remote input interface of the displayed content on the remote screen, according to a gesture which is controlled by a user. At least one gesture switch the input interface to control the content of the first application on the remote screen and at least a second gesture switch the input interface of the computerized mobile device to operate applications on a screen of the computerized device.

The present invention disclose a method for enabling multiple input interfaces on a computerized mobile device.

The method comprising the following steps: enabling first input interface state of the computerized mobile device as a mobile device, supporting stream a content of first application on a remote screen which is different from the displayed content on the mobile device, enabling second input interface state of the computerized mobile device as interface for controlling the displayed content on the remote screen, identifying at least pattern of gesture which is initiated by a user, and determining transition between the input interfaces states of the computerized mobile device and the remote input interface of the displayed content on the remote screen, according to identified gesture pattern.

According to some embodiments of the present invention a first type of gesture pattern switch the input interface to control the content of the first application on the remote screen and at least a second type gesture pattern switch the input interface of the computerized mobile device to operate applications on a screen of the computerized device.

According to some embodiments of the present invention the gesture is related the usage of the smart phone.

According to some embodiments of the present invention the usage of the smart phone include at least one of the following voice gesture, graphic touch gesture, movement pattern of the smart phone.

According to some embodiments of the present invention the gesture is related the behavior of the user, which captured by the smart phone.

According to some embodiments of the present invention the behavior is captured by the a built-in camera of the smart phone.

According to some embodiments of the present invention the triggering the gesture is related the usage of the smart phone.

According to some embodiments of the present invention after a specified period of time, switching to previous input interface with no detected gesture.

According to some embodiments of the present invention the smart phone may be in an intermediate state in which no input interface state is activated.

According to some embodiments of the present invention two smartphone are used as game interface when playing the same game which can be displayed on the smart phone screen or on external screen.

According to some embodiments of the present invention the switching between interface is based on the currently running application, wherein for at least one application is defined the default interface mode.

According to some embodiments of the present invention the remote screen is associated with a receiver module, where the source of the running application is from the receiver module and the input interface is part of the application running on the receiver module, such the transition is between the state of the input interface of the receiving module to input interface of the mobile device

The present invention provides a system for enabling multiple input interfaces on a computerized mobile device.

The system comprised of: interface module for providing default input interface of the computerized mobile device as a mobile device, wherein the input interface of the computerized mobile device is used as a mobile device to stream a content of first application on a remote screen which is different from the displayed content on the mobile device and providing a second input interface state of the computerized mobile device as interface for controlling the displayed content on the remote screen, such that when identifying at least pattern of gesture which is initiated by a user and determining transition between the input interfaces states of the computerized mobile device and the remote input interface of the displayed content on the remote screen, according to identified gesture pattern.

These, additional, and/or other aspects and/or advantages of the present invention are: set forth in the detailed description which follows; possibly inferable from the detailed description; and/or learnable by practice of the present invention.

### BRIEF DESCRIPTION OF DRAWINGS

FIG. 1 is a block diagram of a computerized mobile device with multiple input interfaces, according to some embodiments of the invention;

FIG. 2 shows multiple input interfaces of a computerized mobile device, according to some embodiments of the invention;

FIG. 3 is a flowchart illustrating a method having a computerized mobile device with multiple input interfaces, according to some embodiments of the invention; and

FIG. 4 is a flowchart illustrating a method having a computerized mobile device with multiple input interfaces in an intermediate mode, according to some embodiments of the invention.

FIG. 5 is a flowchart illustrating a method having a computerized mobile device with multiple input interfaces, according to some embodiments of the invention.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The term “computerized mobile device” as used herein in this application, is defined as a mobile device with capability of running applications as well as streaming, projecting and/or displaying multimedia data or applications to a screen that is external to the computerized mobile device (e.g. a mobile phone or a tablet device).

The term “device input interface” as used herein in this application, is defined as an input interface that allows a user to input continuous and multi-dimensional data to a computer (e.g. touch interface).

The term “receiver module ” as used herein in this application, is defined as a processing communication module embedded in a dongle device or integrated in external screen such as TV or monitor device which support managing activating and streaming multimedia application.

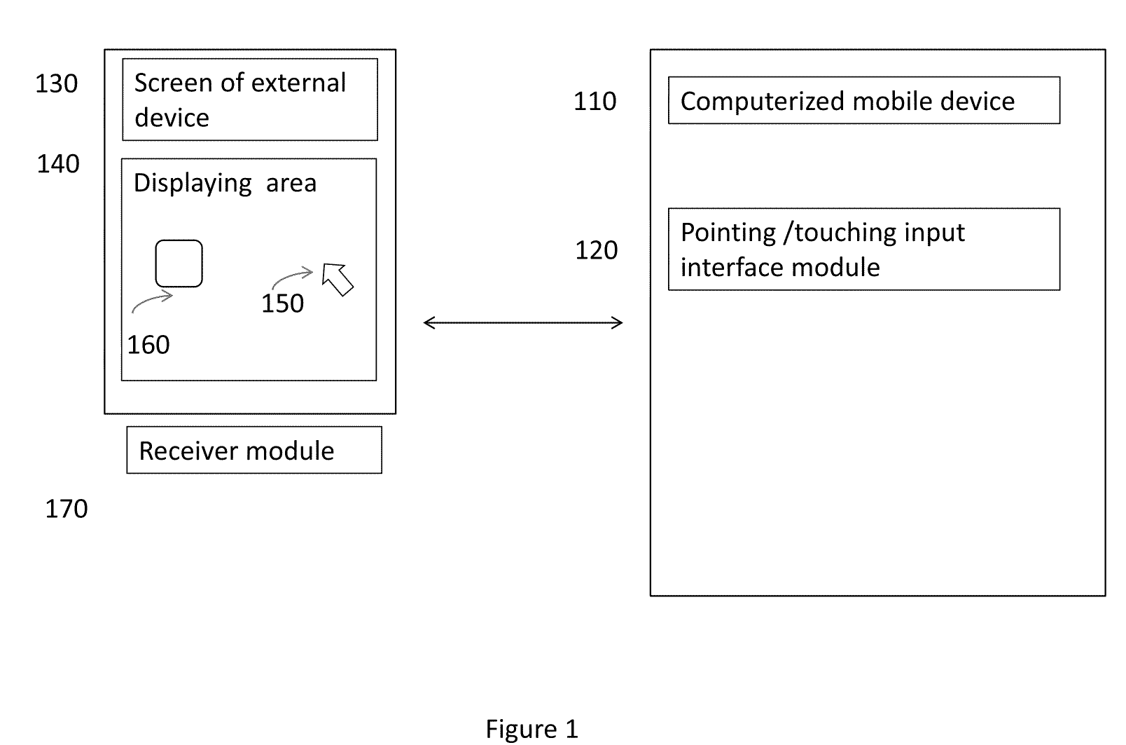

FIG. 1 is a block diagram of a computerized mobile device with multiple input interfaces, according to some embodiments of the invention.

In a non limiting example, the computerized mobile device may be a Smartphone.

According to some embodiments of the present invention, a Smartphone 110 may have multiple input interfaces such as touch screen 120. One of the multiple input interfaces of the computerized mobile device 110 (i.e. Smartphone) may be used as a mobile device including operation of various applications such as making calls, accessing a web browser and entering a contact list. Additionally, while using this input interface of the computerized mobile device 110 as a mobile device it may be switched to another input interface and may be used in a non limiting example, as an input interface of a device to send command instructions to the application to be displayed a remote/external screen 130. The instructions may be to move for example, a mouse cursor 150 on a displaying area 140 or to double click an icon of the application 160 that is displayed in the displaying area 140 to instruct the application 160 to start running. Another example may be a keyboard cursor or other functional keys or as a remote controller of an electronic device such as Air conditioning or television.

According to some embodiments of the present invention, the application 160 that its image is projected on the remote screen 130 and controlled by a remote input interface in the computerized mobile device 110 is different than the application that is being activated with input interface of the computerized mobile device.

According to some embodiments of the present invention the remote screen is associated with a receiver module 170. In such embodiments the source of the running application may be the from the receiver module and the and not from computerized mobile device and the input interface is part of the application running on the receiver module. Accordingly the switching may occur between the state of the input interface of the receiving module to input interface of the mobile device.

In other words, the computerized mobile device (i.e. Smartphone) which initially was running an input interface of an ordinary computerized mobile phone may switch to another input interface with different functioning and perform as a remote input interface of a device and send instructions to another application that is streamed or projected on a remote screen.

According to some embodiments of the present invention, in each and every moment a user may switch between input interfaces on the computerized mobile device 110 (i.e. Smartphone) from an input interface that functions as a computerized mobile device to an input interface that functions as a remote input interface of a device.

For example, while using an input interface of the computerized mobile device as a remote input interface device, a user may receive a phone call. To respond to the received phone call the user may switch to an input interface of a computerized mobile device. Later on, in a non limiting example, while the user is speaking on the phone, the user may switch the input interface of the computerized mobile device from an input interface of a mobile device back to a remote input interface device and use it to remotely control a device.

According to some embodiments of the present invention, switching between the input interfaces of the Smartphone that operates as an input interface of a computerized mobile device to an input interface that operates as a remote input interface of a device may be performed in several ways.

According to some embodiments of the present invention, one way to switch between input interfaces may be by identifying a gesture of the user that is related to the Smartphone device itself. The gesture may be for example, a voice command that may be received by an audio system of the Smartphone, or a touch on the screen of the computerized mobile device 110 (i.e. Smartphone) or a tilt in a specified direction to the computerized mobile device 110.

According to some embodiments of the present invention, another way to switch between input interfaces of the computerized mobile device may be by identifying an external gesture of the user operated by a built-in camera of the computerized mobile device 110 (i.e. Smartphone). For example, the direction to which the user is looking at may signify type of the input interface (i.e. ordinary input interface of a computerized mobile device or a remote input interface of a device).

According to some embodiments of the present invention, another way to switch between input interfaces may be by the position in which the user holds the Smartphone device. For example, holding the computerized mobile device horizontally or vertically. Meaning, the user may switch from holding the Smartphone in a vertical manner while speaking on the phone to a horizontal manner to switch between input interfaces of the Smartphone from an ordinary input interface (i.e. computerized mobile device) to a remote input interface of a device.

According to some embodiments of the present invention, the Smartphone may have a default input interface, for example an input interface of a computerized mobile device. Upon recognition of a trigger the input interface may be switch to a remote input interface of a device and then, after a specified period of time, switch to previous input interface (i.e. input interface of a computerized mobile device).

According to some embodiments of the present invention, the Smartphone may switch between input interfaces according to a trigger it may receive.

According to some embodiments of the present invention, the Smartphone may be in an intermediate state in which no input interface is activated and activate a specific input interface, either an input interface of a computerized mobile device or a remote input interface of a device, according to received triggers.

According to some embodiments of the present invention, there may be an input interface that is running on the Smartphone that may be used by two game players which are playing a game together. In such input interface sate, two smartphone are used as game interface when playing the same game which can be displayed on the smart phone screen or on external screen.

Optionally, one of the smartphone is initiating the game and the game is running on this Smartphone, in this case the second Smartphone which participates in the game can switch the input interface of the second Smartphone to control the game action of the first Smartphone, which is displayed on the external screen.

According to some embodiments of the present invention, the input interface that is activated on the Smartphone may be application oriented; meaning, in case an application that is oriented to be projected to a remote/external screen is loaded it may signify via its Application Programming Input (API) interface that the input interface of the computerized mobile device should be switched to a remote input interface of a device. In case the application that is running on the computerized mobile device is mobile device oriented its API may signify that the input interface that should be activated is of a computerized mobile device.

According to some embodiments of the present invention, in order to control the routing of triggers, meaning, to which window of the Operating System (OS) the triggers are dispatched to, a change in input management/dispatching module of the OS may be performed by hooking into it. Setting of the target/focused window (i.e. the window of OS to which triggers are dispatched) to the one that is displayed in the remote screen (display to which the triggers should be dispatched according to the current routing).

In some OS, such hooking and routing control may be performed in the window management module. The hook will set the focused window to the one in the remote screen (i.e. display to which window of OS the events should be dispatched according to the current routing). For example, in Android OS (ICS, JellyBean versions) the input management/dispatching module is InputDispatcher.

An alternate implementation may be performed by filtering (i.e. capturing and blocking of dispatch) all inputs of the user in the mobile device, and then injecting it to a certain window of the OS or application that is displayed on the remote screen (i.e. display to which the triggers should be dispatched according to the current routing).

According to some embodiments of the present invention, the alternative mode of the input interface may be implemented by using an additional window's layer; this window can receive all input data of the Smartphone and dispatch the information according to the triggering recognition, for switching between the ordinary mode of the input interface and remote control mode.

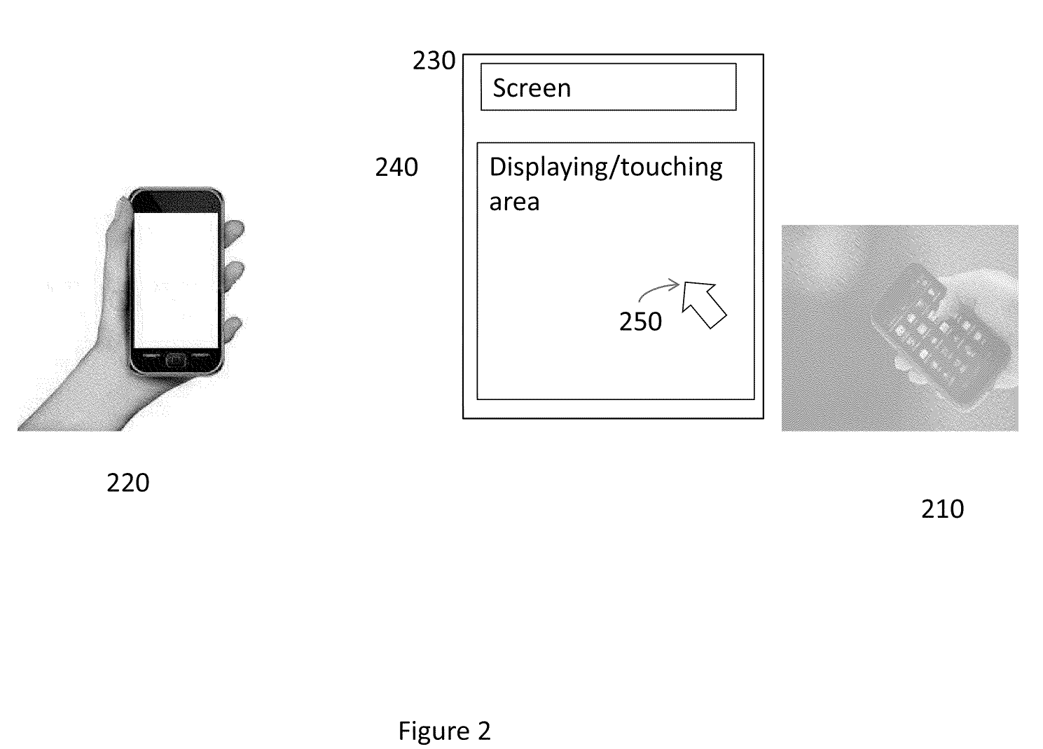

FIG. 2 shows multiple input interfaces of a computerized mobile device, according to some embodiments of the invention.

In a non limiting example, the computerized mobile device may be a Smartphone.

According to some embodiments of the present invention, a user may hold a Smartphone vertically 220 while speaking on the phone or using one of the phones' applications. In a non limiting example, the user may wish to switch the input interface of the smartphone to an input interface of a remote input interface device, so the user may send instructions to another application that is streamed and projected on a remote screen. For example to pause a movie that is streamed from the Smartphone to a remote screen. For that purpose, the user may hold the smartphone 210 horizontally and may point it towards the remote screen 230. Furthermore, the user may send an instruction to a cursor/pointer 250 (or any other cursor or functionality key) to click on a pause key on the application that is streaming to the remote screen 230 (i.e. that is playing the movie). The content of the application that is being streamed is displayed on displaying/touching area 240.

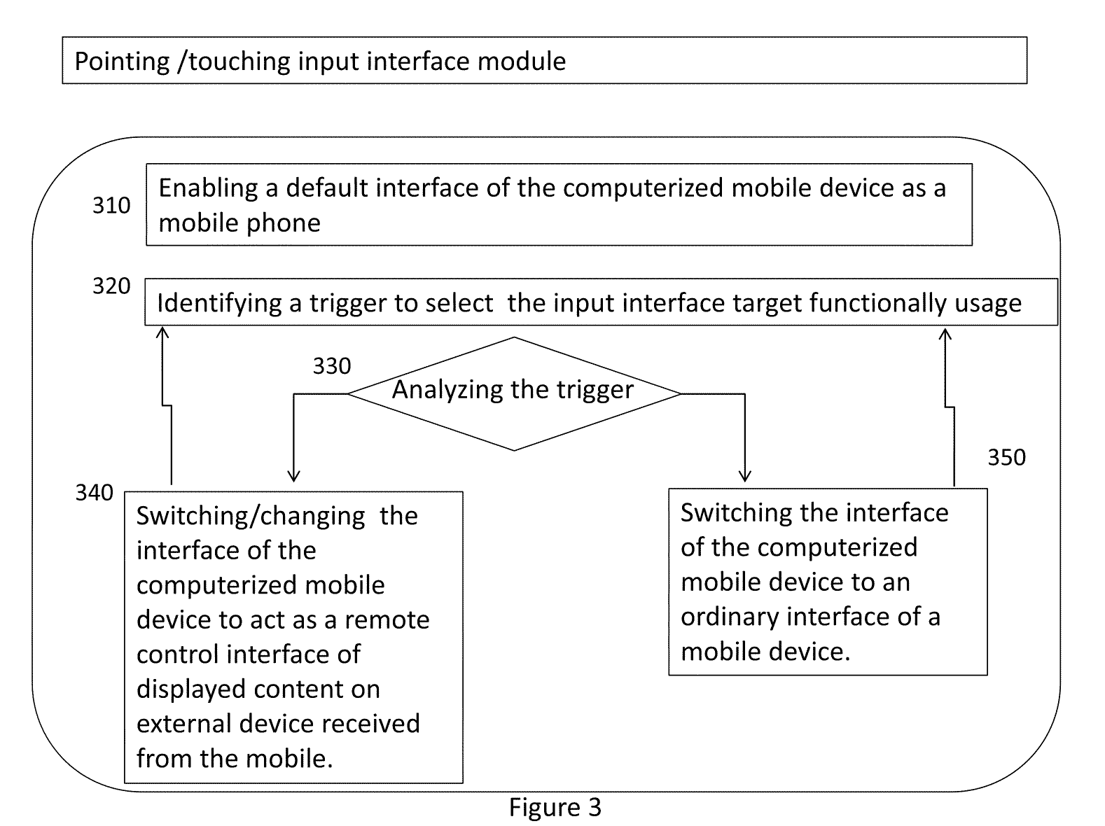

FIG. 3 is a flowchart illustrating a method of having a computerized mobile device with multiple input interfaces, according to some embodiments of the invention.

According to some embodiments of the present invention, one way to implement multiple input interfaces on a computerized mobile device may be to enable a default input interface of the computerized mobile device as an input interface of an ordinary mobile phone (stage 310).

When a trigger is identified to select the input interface target functionally usage (stage 320) the input interface that is currently activated may analyze the trigger (stage 330). In case the trigger was to indicate a remote input interface of a device the input interface may switch to a remote input interface of an external device (stage 340). In case the trigger was to indicate an input interface of an ordinary computerized device the input interface may switch to an input interface of a computerized mobile device, in a non limiting example, to an input interface of a mobile phone (stage 350).

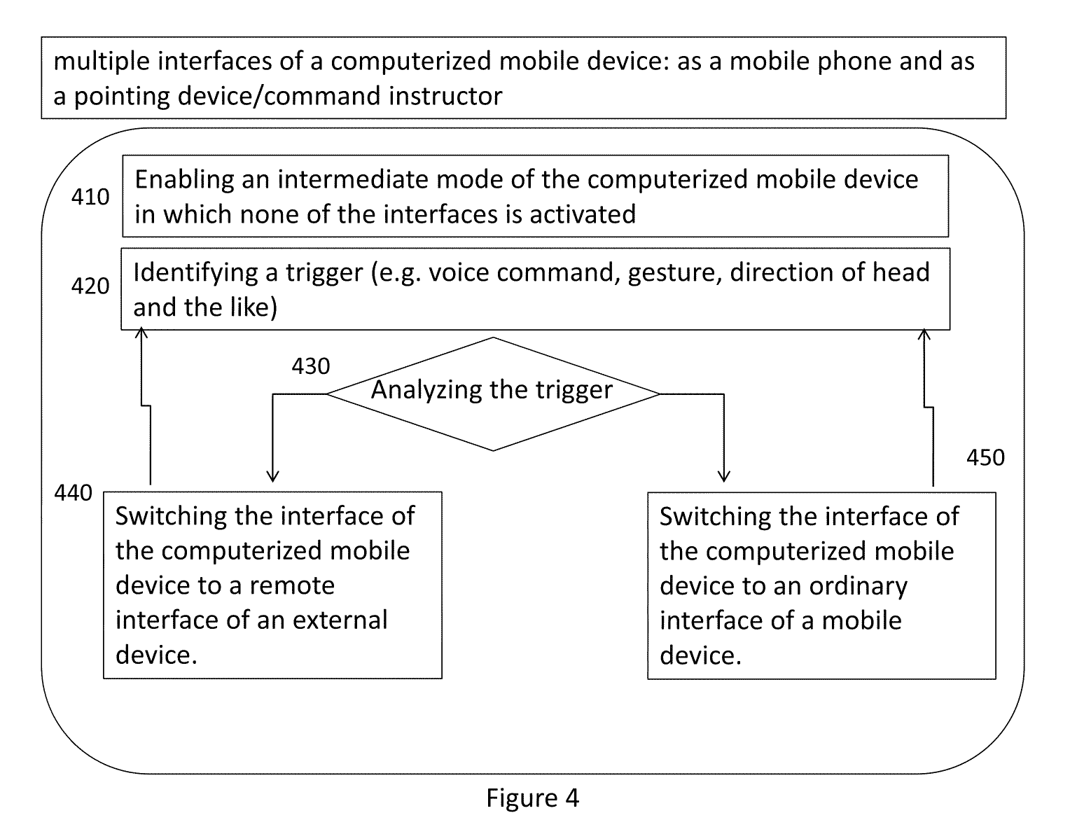

FIG. 4 is a flowchart illustrating a method having a computerized mobile device with multiple input interfaces in an intermediate mode, according to some embodiments of the invention.

According to some embodiments of the present invention, one way to implement multiple input interfaces on a computerized mobile device may be to enable an intermediate mode of the computerized mobile device in which none of the input interfaces is activated (stage 410). In case a trigger is identified (e.g. voice command, gesture, direction of head and the like) (stage 420) the trigger may be analyzed (stage 430).

According to some embodiments of the present invention, in case the trigger was to indicate a remote input interface of a device the input interface may switch to a remote input interface of an external device (stage 440). In case the trigger was to indicate an input interface of an ordinary computerized device the input interface may switch to an input interface of a computerized mobile device, in a non limiting example, to an input interface of a mobile phone (stage 450).

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

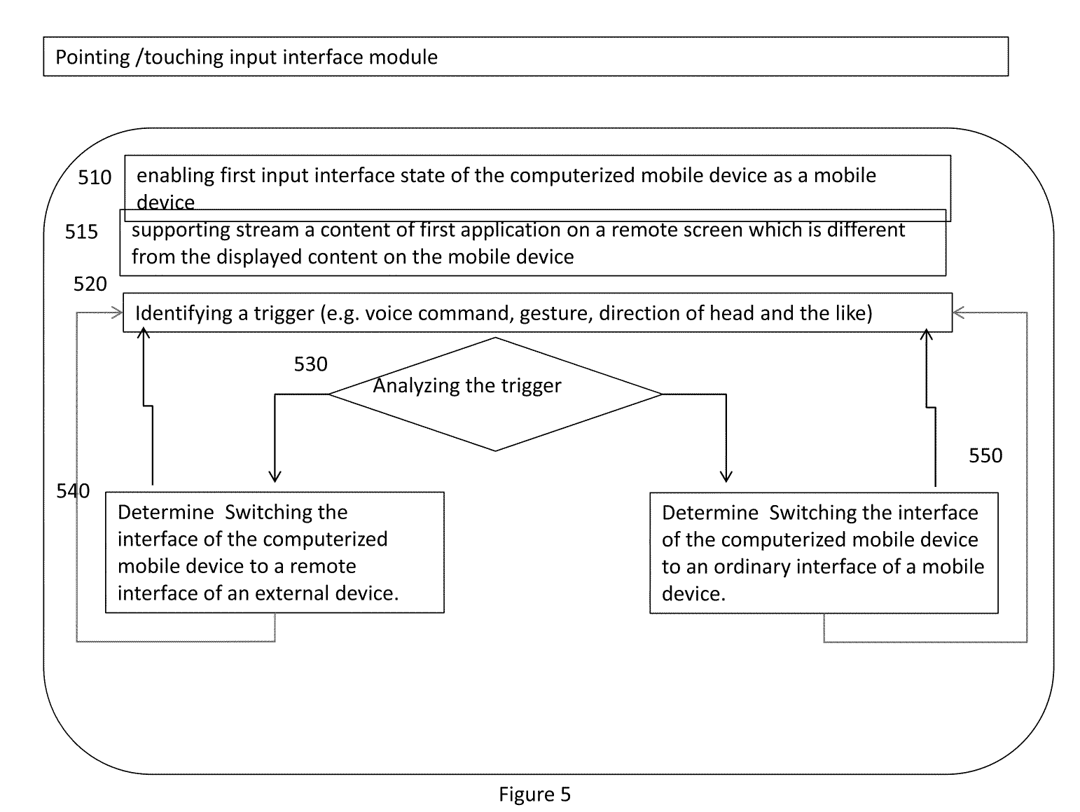

FIG. 5 is a flowchart illustrating a method operation to Pointing /touching input interface module, according to some embodiments of the invention.

According to some embodiments of the present invention, one way to implement multiple input interfaces on a computerized mobile device may be to enable first input interface state of the computerized mobile device as a mobile device (stage 510). The module supports stream a content of first application on a remote screen which is different from the displayed content on the mobile device (step 520).

In case a trigger is identified (e.g. voice command, gesture, direction of head and the like) (stage 530) the trigger may be analyzed (stage 540).

According to some embodiments of the present invention, in case the trigger was to indicate a remote input interface of a device the input interface may switch to state of a remote input interface of an external device (stage 540). In case the trigger was to indicate an input interface of an ordinary computerized device the input interface may switch to sate of an input interface of a computerized mobile device, in a non limiting example, to an input interface of a mobile phone (stage 550).

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

What is claimed is:

1. A method for enabling multiple input interfaces on a computerized mobile device, the method comprising the following steps:
enabling first input interface state of the computerized mobile device as a mobile device;
supporting stream a content of first application on a remote screen which is different from the displayed content on the mobile device;
enabling second input interface state of the computerized mobile device as interface for controlling the displayed content on the remote screen;
identifying at least pattern of gesture which is initiated by a user, and;
determining transition between the input interfaces states of the computerized mobile device and the remote input interface of the displayed content on the remote screen, according to identified gesture pattern.

2. The method of claim 1 wherein a first type of gesture pattern switch the input interface to control the content of the first application on the remote screen and at least a second type gesture pattern switch the input interface of the computerized mobile device to operate applications on a screen of the computerized device.

3. The method of claim 1 the gesture is related the usage of the smart phone.

4. The method of claim 1 wherein the usage of the smart phone include at least one of the following voice gesture, graphic touch gesture, movement pattern of the smart phone.

5. The method of claim 1, wherein the gesture is related the behavior of the user, which captured by the smart phone.

6. The method of claim 4 wherein the behavior is captured by the a built-in camera of the smart phone.

7. The method of claim 1 , wherein the triggering the gesture is related the usage of the smart phone.

8. The method of claim 1 wherein after a specified period of time, switching to previous input interface with no detected gesture.

9. The method of claim 1 wherein the smart phone may be in an intermediate state in which no input interface state is activated.

10. The method of claim 1 wherein two smartphone are used as game interface when playing the same game which can be displayed on the smart phone screen or on external screen.

11. The method of claim 1 wherein the switching between interface is based on the currently running application, wherein for at least one application is defined the default interface mode.

12. The method of claim 1 wherein the remote screen is associated with a receiver module, where the source of the running application is from the receiver module and the input interface is part of the application running on the receiver module, such the transition is between the state of the input interface of the receiving module to input interface of the mobile device

13. A system for enabling multiple input interfaces on a computerized mobile device, the system comprised of:
interface module for providing default input interface of the computerized mobile device as a mobile device, wherein the input interface of the computerized mobile device is used as a mobile device to stream a content of first application on a remote screen which is different from the displayed content on the mobile device and providing a second input interface state of the computerized mobile device as interface for controlling the displayed content on the remote screen, such that when identifying at least pattern of gesture which is initiated by a user, is determined transition between the input interfaces states of the computerized mobile device and the remote input interface of the displayed content on the remote screen, according to identified gesture pattern.

14. The system of claim 13 wherein a first type of gesture pattern switch the input interface to control the content of the first application on the remote screen and at least a second type gesture pattern switch the input interface of the computerized mobile device to operate applications on a screen of the computerized device.

15. The system of claim 13 wherein the gesture is related the usage of the smart phone.

16. The system of claim 13 wherein the usage of the smart phone include at least one of the following voice gesture, graphic touch gesture, movement pattern of the smart phone.

17. The system of claim 13 wherein the gesture is related the behavior of the user, which captured by the smart phone.

18. The system of claim 17 wherein the behavior is captured by the a built-in camera of the smart phone.

19. The system of claim 13 wherein the triggering the gesture is related the usage of the smart phone.

20. The system of claim 13 wherein after a specified period of time, switching to previous input interface with no detected gesture.

21. The system of claim 13 wherein the smart phone may be in an intermediate state in which no input interface state is activated.

22. The system of claim 13 wherein two smartphone are used as game interface when playing the same game which can be displayed on the smart phone screen or on external screen.

23. The system of claim 13 wherein the switching between interface is based on the currently running application, wherein for at least one application is defined the default interface mode.

24. The system of claim 13 wherein the remote screen is associated with a receiver module, where the source of the running application is from the receiver module and the input interface is part of the application running on the receiver module, such the transition is between the state of the input interface of the receiving module to input interface of the mobile device
